(19) United States
(12) Patent Application Publication
(10) Pub. No.: US 2025/0200372 A1
(43) Pub. Date: Jun. 19, 2025

(54) SOFTWARE-BASED MASS CUSTOMIZATION OF ARTIFICIAL NEURAL NETWORKS

(71) Applicants: Jeremy Straub, Fargo, ND (US); Dominic Rosch-Grace, Fargo, ND (US); Jordan Milbrath, Fargo, ND (US); Jonathan M. Rivard, Fargo, ND (US)

(72) Inventors: Jeremy Straub, Fargo, ND (US); Dominic Rosch-Grace, Fargo, ND (US); Jordan Milbrath, Fargo, ND (US); Jonathan M. Rivard, Fargo, ND (US)

(21) Appl. No.: 18/980,354

(22) Filed: Dec. 13, 2024

Related U.S. Application Data
(60) Provisional application No. 63/733,230, filed on Dec. 12, 2024.
(60) Provisional application No. 63/610,308, filed on Dec. 14, 2023.

(51) Int. Cl. G06N 3/082; G06N 3/045

(52) U.S. Cl. CPC G06N 3/082; G06N 3/045

(57) ABSTRACT

The subject matter as disclosed herein provides a system and method for improving neural network development efficiency through a visual development interface and customization framework. The system implements a coordinate-based mapping system that enables precise component tracking through spatial identification based on layer position and placement order, which reduces computational overhead. The interface provides drag-and-drop model creation capabilities alongside granular neuron-level customization. Users can modify activation functions, weight initializations, and connectivity patterns for individual neurons. The system supports creation of heterogeneous neural networks with non-uniform architectures and enables implementation of constant node networks and amalgamated configurations. Real-time visualization capabilities provide both high-level architectural views and detailed component-level information. Automated logic generation translates visual representations into optimized backend code. The system delivers measurable technical benefits including improved processing efficiency, reduced resource requirements, and accelerated development processes through automated batch operations and immediate optimization capabilities.

### CROSS-REFERENCE TO RELATED APPLICATIONS

This application claims priority to U.S. Provisional Pat. Appl. No. 63/610,308, titled “SOFTWARE-BASED MASS CUSTOMIZATION OF ARTIFICIAL NEURAL NETWORKS AND ITS BENEFITS,” filed Dec. 14, 2023, and to U.S. Provisional Pat. Appl. No. 63/733,230, titled “GRADIENT-TRAINED RULE-FACT NETWORKS,” filed Dec. 12, 2024, which are hereby incorporated by reference herein in their entirety.

### BACKGROUND

Artificial intelligence (AI) is a rapidly growing field of research that aims to create decision-making computing systems Machine learning (ML) is a subclass of AI that processes vast quantities of data to train computational models. ML agents can identify patterns in large datasets and render predictions based on the data they were trained with. Deep learning (DL) is a subclass of ML that develops artificial neural networks with multiple hidden layers of artificial neurons to solve data-intensive problems. ML and DL research requires specialized knowledge and systems, keeping many organizations from using it or achieving the full benefits it could provide.

Modern society is full of numerous artificially intelligent systems, which range in functionality from performing simple logic-based decision making to more complex systems that learn from the results of prior decisions. These latter systems use ML. With ML, computing systems are given the ability to train themselves using the potentially vast quantities of problem-specific data that they are given. ML systems are used to make analytical decisions by identifying patterns in large datasets, and they do so significantly faster than human analysts. They can also be trained to make decisions or classifications based on a training, validation, and presentation process. They are used in areas such as computer vision, economic forecasting, and natural language processing.

While numerous applications of its successful use exist, AI, ML, and deep learning (DL) research and development is impaired by issues such as explainability, data scarcity, and a lack of access to the technology amongst those not possessing considerable resources and knowledge in the field.

### BRIEF DESCRIPTION OF THE DRAWINGS

In the drawings, which are not necessarily drawn to scale, like numerals may describe similar components in different views. Like numerals that have different letter suffixes may represent different instances of similar components. Some embodiments are illustrated by way of example, and not limitation, in the figures of the accompanying drawings.

FIGS. 1A-1D are diagrams comparing biological and AI neurons, according to an embodiment.

FIG. 2 is a diagram showing a computation of a single neuron, according to an embodiment.

FIG. 3 shows a diagram of a model development process, according to an embodiment.

FIG. 4 shows a diagram of a typical homogonous neural network, according to an embodiment.

FIG. 5 shows a diagram of a customized neural network, according to an embodiment.

FIG. 6 shows a diagram of a constant node network, according to an embodiment.

FIG. 7 is flowchart depicting a method for improving neural network development efficiency, in accordance with at least one embodiment of the invention.

FIG. 8 is a block diagram of a computing device, according to an embodiment.

### DETAILED DESCRIPTION

The subject matter described herein provides solutions to technical problems facing AI, ML and DL models. In particular, the systems and methods described herein provide a user-friendly approach to building AI, ML and DL models is presented which allows users to build models using diagramming software, thus abstracting much of the complexity otherwise associated with building them, while also achieving benefits potentially only available via customization. This allows users to customize models at the artificial neuron level, allowing them to specify attributes such as individual neurons' activation functions and connectivity. This provides improved availability of ML/DL technologies and unlock the benefits of low-level customization for users of all sizes.

The subject matter disclosed herein addresses several challenges in artificial intelligence, machine learning, and deep learning development through innovative solutions that mitigate limitations in complexity, data processing, and visualization. It provides a more accessible implementation process by reducing reliance on manual configuration through script commands. This broadens accessibility to organizations with varying levels of expertise. Additionally, it resolves inefficiencies in processing large volumes of data, managing limited datasets, and addressing hardware constraints. The system improves understanding of neural network architecture, component tracking, and decision pathway visualization, which are common issues in existing technologies.

The disclosed system offers technical advancements, including an enhanced visual development interface, optimized component management, and an advanced customization framework. It introduces a drag-and-drop diagramming interface for network creation, enabling automated batch creation alongside manual customization of components. Real-time visualization capabilities allow for inspection of both high-level architectures and detailed component interactions. These features facilitate more efficient development processes compared to conventional systems with limited visualization and manual-only configuration.

The subject matter disclosed herein also incorporates a coordinate-based mapping system that enables precise component management. By assigning unique spatial coordinates based on layer position and placement order, the system allows for accurate access to specific neurons. This feature facilitates efficient tracking and manipulation of network elements, reducing computational overhead and improving the speed of network modifications. These capabilities enhance tracking mechanisms that are less efficient in alternative systems.

The system includes an advanced customization framework that supports real-time modification of activation functions, dynamic weight initialization, and non-uniform connectivity patterns. These features offer benefits over other solutions that do not support dynamic adaptation of neural network configurations during development. Users can create sophisticated and heterogeneous neural network architectures, including those with varying activation functions and constant node networks. These configurations are challenging to achieve using conventional methods that often rely on static, predefined architectures.

Several features of the disclosed system provide additional improvements. The coordinate mapping system assigns unique spatial identifiers, enabling precise neuron tracking and reducing memory overhead. A dynamic visualization engine optimizes user interaction by providing real-time architectural detail and component inspection. Automated logic generation translates visual representations into optimized backend code, maintaining synchronization between visual and logical elements and enabling specialized configurations for specific applications. These features provide advantages over systems that do not offer real-time updates or synchronization between graphical and backend components.

These features deliver measurable technical benefits. Processing efficiency improves through streamlined component tracking and direct network manipulation. Resource optimization reduces hardware requirements and memory usage, while intelligent component management minimizes processing loads. Development processes accelerate through automated batch operations, rapid experimentation, and immediate application of optimizations. The disclosed system facilitates the creation of sophisticated neural network architectures while addressing challenges not resolved by existing technologies, enabling broader and more effective use of advanced neural network designs.

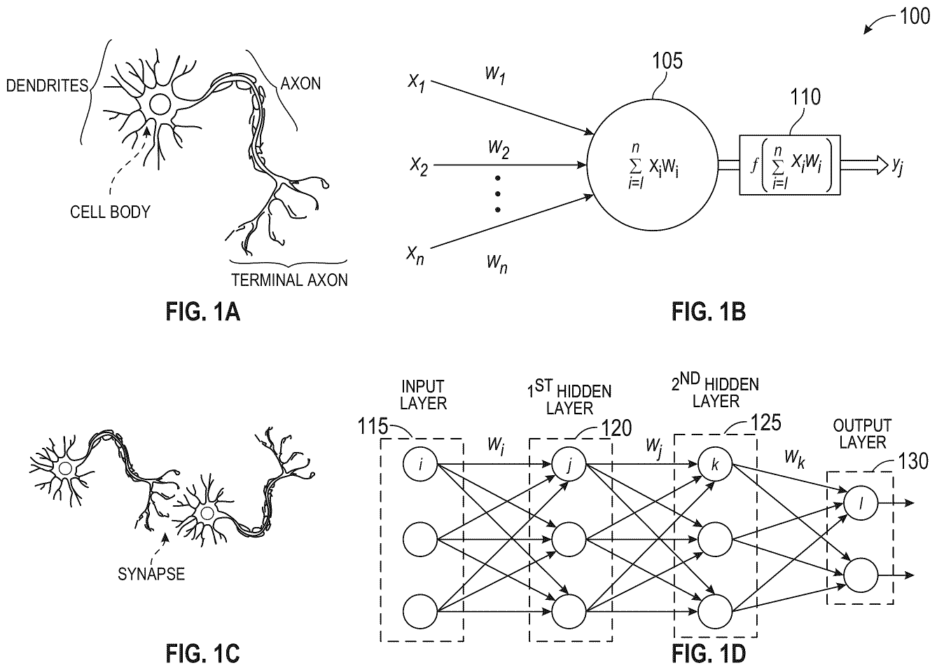

FIGS. 1A-1D are diagrams comparing biological and AI neurons 100, according to an embodiment. Deep Learning (DL) is a subclass of ML that aims to make decisions using a human-like network of neurons in a multi-later deep artificial neural network (DNN). The concepts of DL are derived from elements of ML, which are largely based on the principles of AI. Accordingly, DL could be viewed as a specialized form of AI intended for data-intensive applications.

The mechanics of artificial neural networks (ANNs) and DNNs are loosely inspired by the cognitive functionality of animal brains, and are comprised of artificial neurons with complex interconnectivity via artificial synapses. This interconnectivity allows DL systems to identify patterns in considerably large sets of data, many of which could go unnoticed by a human analyst. FIGS. 1A-1D contrast artificial neurons and their biological counterparts, showing similarities between animal and computing neural networks.

As shown in FIG. 1A, a biological neuron includes dendrites, a cell body, and an axon with terminal axon branches. FIG. 1B illustrates the mathematical representation of an artificial neuron, showing input values with corresponding weight values combined 105 and being processed through a summation function 105 and an activation function 110 to produce an output. FIG. 1C depicts a synapse connection between neurons, showing how signals are transmitted between connected nodes. The connection strength is determined by the weight value associated with the synapse.

FIG. 1D illustrates the layered architecture of a neural network, comprising an input layer 115, first hidden layer 120, second hidden layer 125, and output layer 130. The connections between layers are characterized by weight values (wᵢ, wⱼ, wₖ) that determine the strength of signal transmission between neurons in adjacent layers. This architecture enables the network to process information through multiple stages of transformation, with each layer contributing to the overall computational capability of the network.

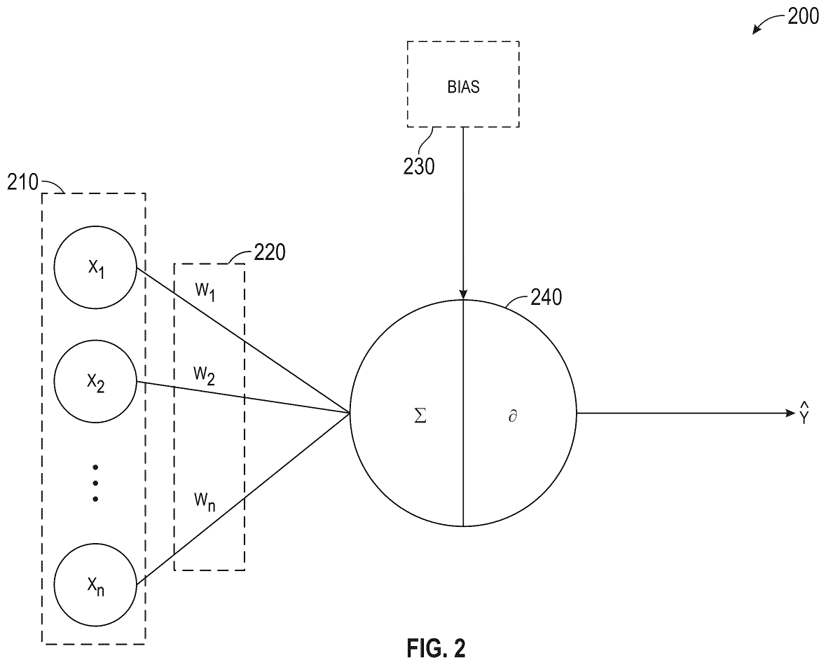

FIG. 2 is a diagram showing a single neuron computation 200, according to an embodiment. The neuron receives multiple inputs (x₁, x₂, . . . , xₙ) through input connections 210, with each input being modified by corresponding weight values (w₁, w₂, . . . , wₙ) through weight connections 220. A bias input 230 is also applied to the neuron. The weighted inputs and bias are processed through a summation function and activation function 240 to produce the output Y. A formula for calculating the summation of the input layer values is given by the equation (1):

$$Z = {\sum }_{i = 1}^{n} ( {x}_{n} \cdot {x}_{n} ) + b \qquad ( 1 )$$

where xₙ represents the neuron's input values, wₙ represents the corresponding weight value, and b is the neuron's bias value. The output (z) is then sent through an activation function to calculate the neuron's output as shown in the equation (2):

$$\hat{Y} = σ ( z ) \qquad ( 2 )$$

where σ represents the activation function and Ŷ denotes the neuron's output.

When the network outputs a prediction, a loss function is applied to compute the difference between the expected and actual value given by the network. Often, the mean square error function is used to compute the magnitude of difference as given by the equation (3):

$$M S E = \frac{{\sum }_{i = 1}^{n} ( {y}_{i} - {\hat{y}}_{i} )}{n} \qquad ( 3 )$$

This loss function is then used to implement backpropagation, which aims to minimize the loss for subsequent iterations, often using stochastic gradient descent. Backpropagation may be used to adjust weights and biases of the neural network to a degree determined by the calculated gradient of the loss function with respect to the network's weights for a single training example. The formula for neural network backpropagation is given by the equation (4):

$${θ}^{t + 1} = θ - α \frac{\partial E ( X , {θ}^{t} )}{\partial θ} \qquad ( 4 )$$

where θ^{t} represents the collective weights and biases of the network at iteration t, E represents the error function used, and a denotes the model's learning rate.

The cycle of feeding information through the network and subsequentially adjusting weight and bias values is repeated until the model is considered to be fully trained. Whether a model is fully trained is determined by those who implemented it, based on the accuracy of the model being assessed using evaluation data.

The ability for deep learning systems to learn from data provides benefits in several areas of research and industry. Examples include fraud detection, vehicular autonomy, hyperspectral image classification, and healthcare. Despite these capabilities, deep learning research faces several challenges, such as algorithms needing vast amounts of data to be effective, the lack of explainability of certain processes, the tendency for models to overfit data, and substantial hardware requirements. The systems and methods disclosed herein aim to improve these issues by allowing more individuals and organizations to experiment with deep learning technologies, thus increasing the possibility of new concepts and techniques being developed.

While machine learning can be effective, many techniques offer limited information about their operation. “eXplainable” artificial intelligence (XAI) techniques can help users understand AI processes, particularly for decisions that impact safety or have significant human effects. These techniques can be categorized into two functional groups: those that are inherently transparent and those that add transparency to existing techniques. They can also be grouped based on whether they are model-agnostic or model-specific.

Explainable techniques provide advantages for a variety of applications. Examples of the use of explainable techniques may include intrusion detection security systems, systems for planning “small-unit tactical behavior,” and lending, sales, and fraud detection systems. However, present explainable AI capabilities are insufficient for some application areas and are limited in that they can only explain past decisions instead of guaranteeing the accuracy of future decisions.

A particular explainable technique, which is based on applying machine learning principles to an expert system, uses gradient descent machine learning directly on the rule-fact network of an expert system. This technique optimizes the network itself and prevents the underlying rule-fact network from changing, thus preventing the learning of invalid associations and decision-making pathways.

The system distributes a portion of the difference between the current and ideal outputs to the weightings applied to rules, similar to conventional neural networks. Due to its expert systems heritage, rules and facts have specific meanings. This means that system networks are typically irregularly shaped, and that they can be manually interacted with to optimize network performance.

Irregular neural networks have also been proposed, including compressing networks and removing layering. Other proposals include the pruning of neural networks, which usually results in an irregular network structure. These irregular-style networks may have operational speed and performance optimization benefits. Facilitating their development and customization is a goal of the disclosed subject matter.

The disclosed systems and methods are designed to facilitate the creation of a neural network via diagramming. The user interface allows a user to design the NN architecture using a drag-and-drop-style diagramming interface. This enables users to quickly view their intended model and automates the process of creating the backend logic of the NN system based on this model.

For hidden layers containing numerous neurons, the system allows the user to specify the number of neurons for each layer or a collection of layers and creates them in a batch. It allows users to specify parameters such as the initialized weight values, activation functions, and the network backpropagation method and learning rate.

The system's workspace uses a mapping system, which is a cartesian plane coordinate space, where the location of NN components is denoted by the layer in which they are contained, and the order in which they are placed within the layer. For example, a topmost neuron in the first hidden layer would be located at L: 1, N: 1. The system also contains a function for accessing a specific neuron within the user's workspace using this coordinate system. This enables users to keep track of NN components more easily for large NN models.

While the disclosed system design allows the rapid creation of homogonous networks, it also provides the ability for users to customize the model at the level of the individual neuron. For example, a user may opt to modify a neuron within a hidden layer by reconfiguring its activation function. Alternately, a user could set different initial values for numerous neurons. The disclosed platform, therefore, allows users to experiment with different neural network parameters and configurations to tune the network to fit their application area, combining the automation of manually intensive tasks with the ability to make granular customizations as desired.

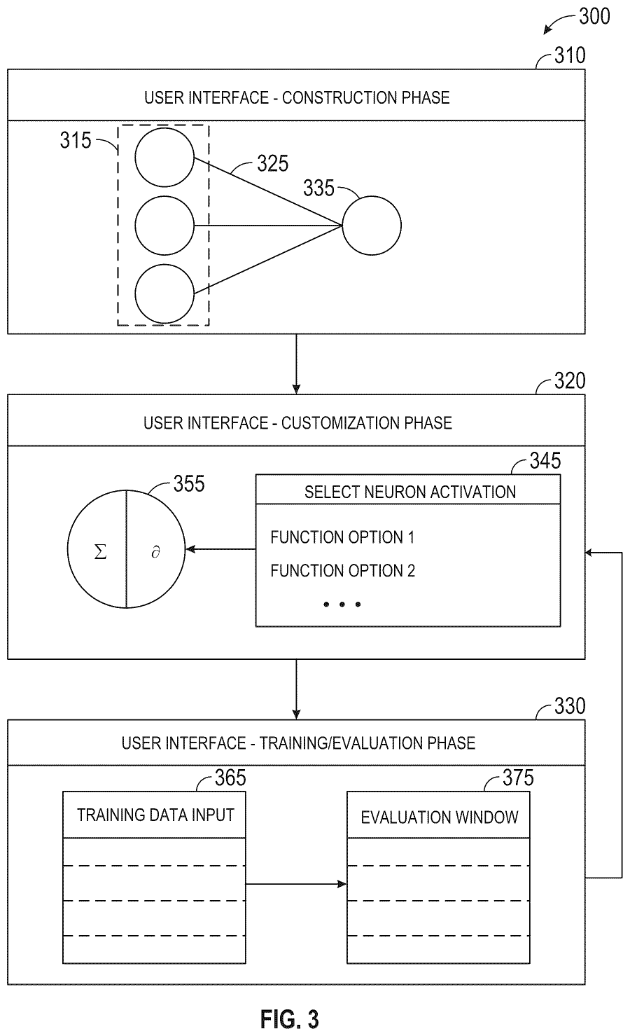

FIG. 3 shows a diagram of a model development process 300, according to an embodiment. As shown in FIG. 3, the model development process 300 is comprised of three major phases: a construction phase 310, a customization phase 320, and a training and evaluation phase 330. While model development process 300 shows the three phases sequentially, a user may perform the second and third phases multiple times as they are attempting to optimize the performance of the network.

The model development process 300 may begin with the construction phase 310. The initial neural network model can be created by either dragging and dropping input layers 315 (e.g., input nodes), one or more output nodes 335, and link objects 325 connecting the input layers 315 and the one or more output nodes 335. A user may also specify a number of neurons for each layer and a number of layers. These two approaches can be combined, with the user creating some of the network using the automation capability and then augmenting the automated-creation network with manually created nodes. Alternately, the user could manually create some nodes (e.g., input and output layers) and then fill in other parts of the network using automation.

In addition to creating nodes in the construction phase 310, the system provides the user with the capability to visualize their neural network model. This can help the user gain both a high-level and low-level understanding of the model, as well as how these two levels of detail are interrelated.

The model development process 300 may continue with the customization phase 320. The customization phase 320 provides a user interface that includes neuron selection options 345 and activation function options 355. Following the initial creation of the neural network (NN) model, the user has the opportunity to customize neurons at their discretion. During this customization phase 320, users can customize individual neurons by modifying their attributes to create heterogeneous networks. This is principally designed to allow granular editing of the automated-creation neurons, but any neuron can be edited. This allows attributes of the neurons to be customized to create a heterogeneous network. Users can alter characteristics such as the sources of neuron inputs, their activation functions, biases, and output destinations.

After the customizations are completed during the customization phase 320, users can save, train, and evaluate the model in the training and evaluation phase 330. The system design also includes the capability to integrate with NN operations software. This capability provides a training data input window 365 and an evaluation window 375. The training data input window 365 provides a space to supply (e.g., manually enter or upload a text file) training examples, such as line delimited training examples. This allows the user to supply curated training data to test the system and provide a rapid assessment of the system's performance. From here, the user can also start the training procedure.

Similarly, the system design includes an evaluation window 375 that allows the user to supply (e.g., manually enter or upload a text file) evaluation data. Once the training is completed, to the level determined by the user, they can begin the presentation and evaluation process. The evaluation data is then used to analyze the accuracy of the created model.

The system is designed so that the user has the ability to return to the customization window, retaining their built NN, enabling them to experiment with different NN characteristics. The user can assess the system's performance and then return to make changes and assess it again. Users may also be provided with an option to save and load models, which may be used when developing a new model or returning to an earlier model at a later point.

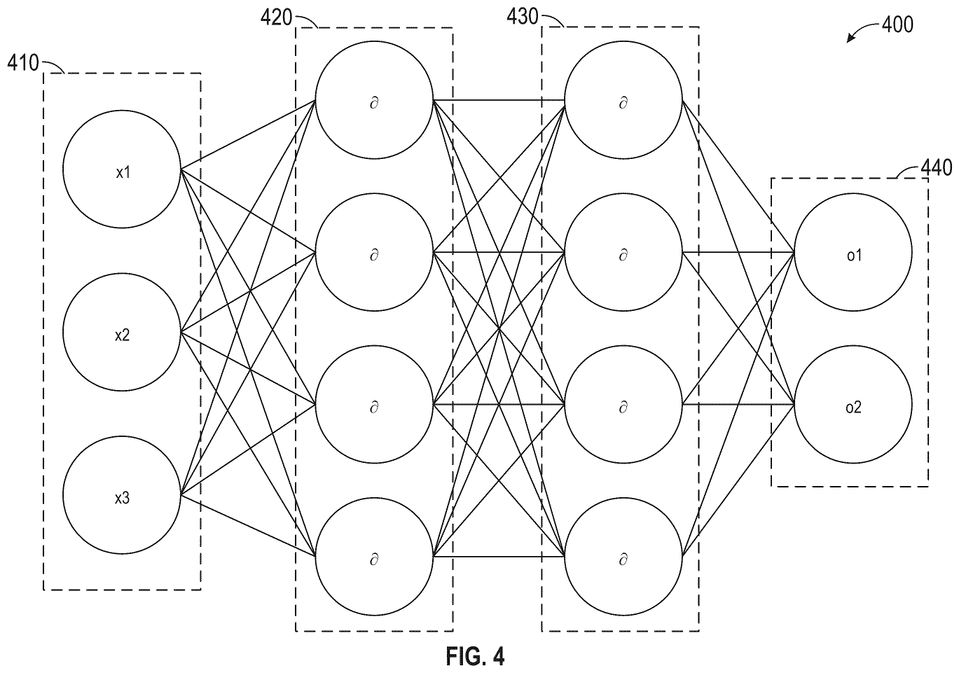

FIG. 4 shows a diagram of a typical homogeneous neural network 400, according to an embodiment. This typical homogeneous neural network 400 may include input layer 410, first hidden layer 420, second hidden layer 430, and output layer 440.

The system described herein is based on the advantages of heterogeneous neural network configurations. Irregular networks have been used with typical neural network algorithms. Neural network customization may facilitate the creation of higher performance networks that excel in particular subsets of a problem domain, specific identifications, or particular data types. This customization allows attributes of neurons, which are generally not altered during the training process, such as the activation function, to be modified.

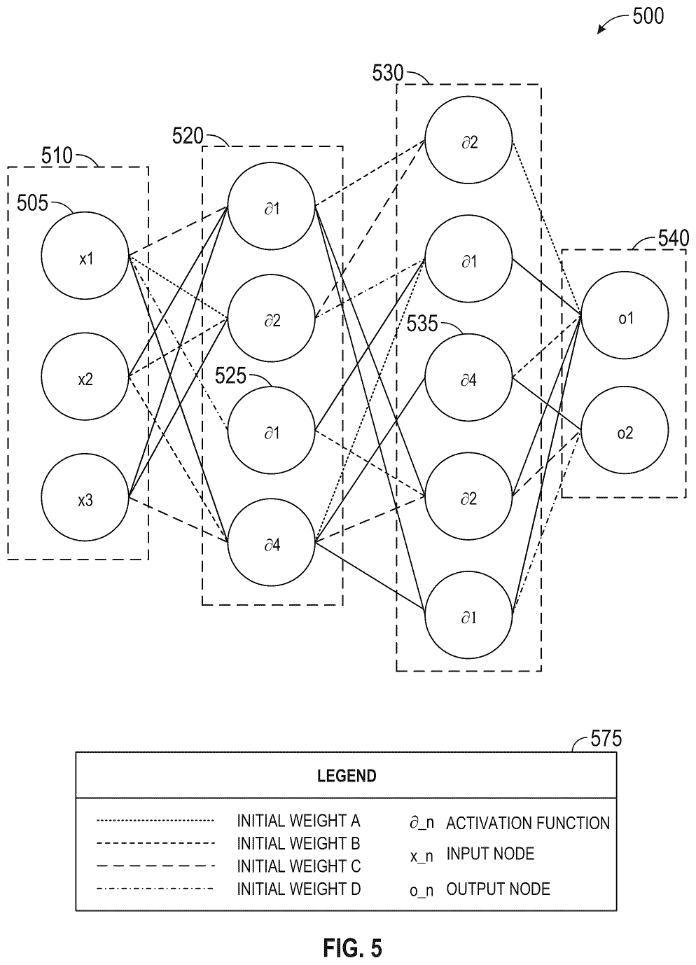

The effects of this type of customization are shown in FIG. 4 and FIG. 5. FIG. 4 depicts a homogeneous neural network, which is typical of many modern neural network implementations. This network comprises hidden layer neurons that all use the same activation function and weight initialization functions. This figure also illustrates the homogeneity of the neural network's internal node connectivity. A single node receives its input from all nodes in the preceding layer, while outputting its own computation to all neurons in the subsequent layer.

FIG. 5 shows a diagram of a customized neural network 500, according to an embodiment. The customized neural network 500 depicts a neural network model of the type that could be created using the proposed system.

Similar to the typical homogeneous neural network 400 shown in FIG. 4, this customized neural network 500 may include an input layer 510, a first hidden layer 520, a second hidden layer 530, and an output layer 540. However, a number of distinctions exist between the typical homogeneous neural network 400 shown in FIG. 4 and the customized neural network 500 shown in FIG. 5. The weights used between nodes may be weighted differently, such as the four initial weight values shown in the legend 575. The activation functions used in the first hidden layer 520 may differ from the activation functions used in the second hidden layer 530.

The customized neural network 500 may also use a varied connectivity between nodes. For example, input node 505 may connect to all nodes in the first hidden layer 520, whereas the first activation function 525 in the first hidden layer 520 may connect only to input node 505. The fourth activation function 535 in the second hidden layer 530 may connect only to a single node in the first hidden layer 520.

The proposed system may also facilitate the creation of amalgamated networks that combine different configurations into a broader system. These configurations may be trained individually before combination. This amalgamated system, developed in this manner, could be initially trained or further trained if components were pre-trained, such as to optimize across several different decision component areas.

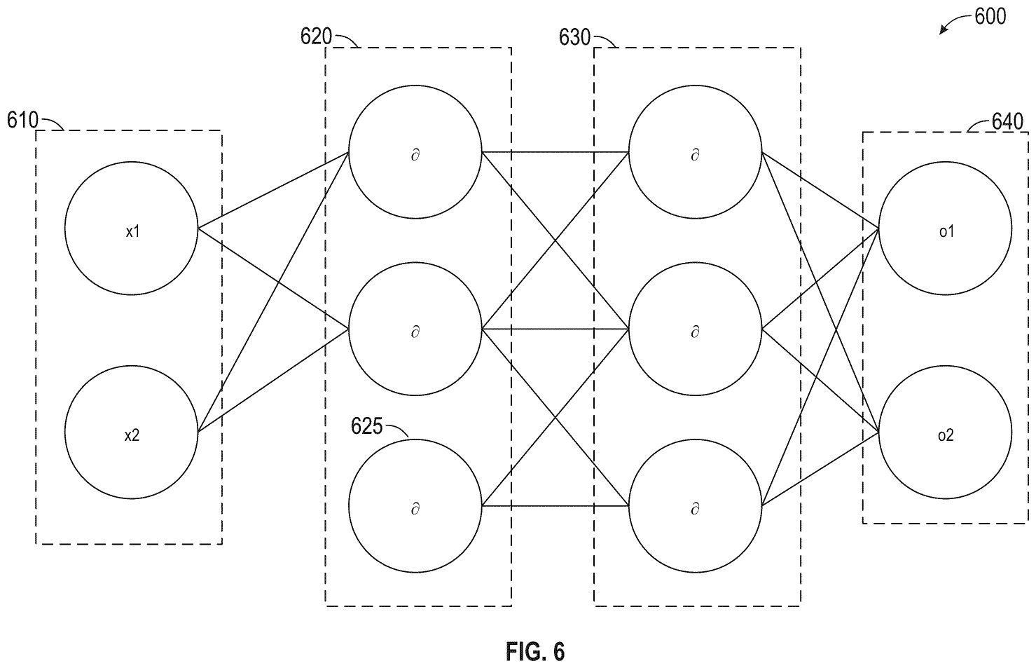

FIG. 6 shows a diagram of a constant node network 600, according to an embodiment. The network includes input nodes 610, first hidden layer 620, second hidden layer 630, and output nodes 640. A distinguishing feature of this network is the constant node 625 within first hidden layer 620, which represents a neuron with no inputs that maintains a fixed value. The constant node 625 provides a consistent signal to connected nodes in the network, enabling specialized network behavior. This configuration demonstrates how constant nodes can be integrated beyond traditional input layers to influence network computations.

The systems and methods disclosed herein may be used in gradient descent trained expert systems (GDTES). These systems were initially designed to be manually configured; however, some solutions may use an automated technique for their development.

Nodes within GDTES have a direct correlation to real-world facts and rules. Facts correlate to information about the real world, and rules model real-world processes and relationships. Because nodes within GDTES correlate to the real world, humans can intuitively create these systems. The disclosed system improves the ability to create GDTES, changing the creation process from the development of script commands to a more graphical and intuitive one.

The disclosed system could allow traditional neural networks and GDTES networks to be integrated or interconnected. It would facilitate interaction and experimentation between different artificial intelligence, machine learning, and neural network technologies. This could be used to create and evaluate various hybrid system designs. It could lead to new discoveries in the artificial intelligence field and create other opportunities for potential future work.

The disclosed system facilitates the creation of neural networks with limited knowledge of the underlying system functionality. Customization may require knowledge of the effect of network attribute decisions; however, this is less complex than understanding the underlying technology and theory of operations. Thus, the disclosed systems and methods enable more organizations and users within the organizations to experiment with and implement neural network technologies to solve their challenges.

The system is designed with an easy-to-use user interface. This interface enables users to build and customize their neural networks while saving time through automated processes. The customizable nature of the models developed through the disclosed system facilitates experimentation with different network configurations, training data sets, subsets of training data sets, and various parameter settings when developing a neural network for an application area. The system may facilitate research and the discovery of broader improvements to artificial intelligence, neural network, and deep neural network technologies.

The systems and methods disclosed herein improve the process of developing and implementing neural networks. This includes abstracting many of the higher-level concepts and lower-level implementation details of neural network development. The systems and methods may be customized based on the level of user knowledge. This may drive the inclusion of new features or capabilities and create new opportunities for system-related research.

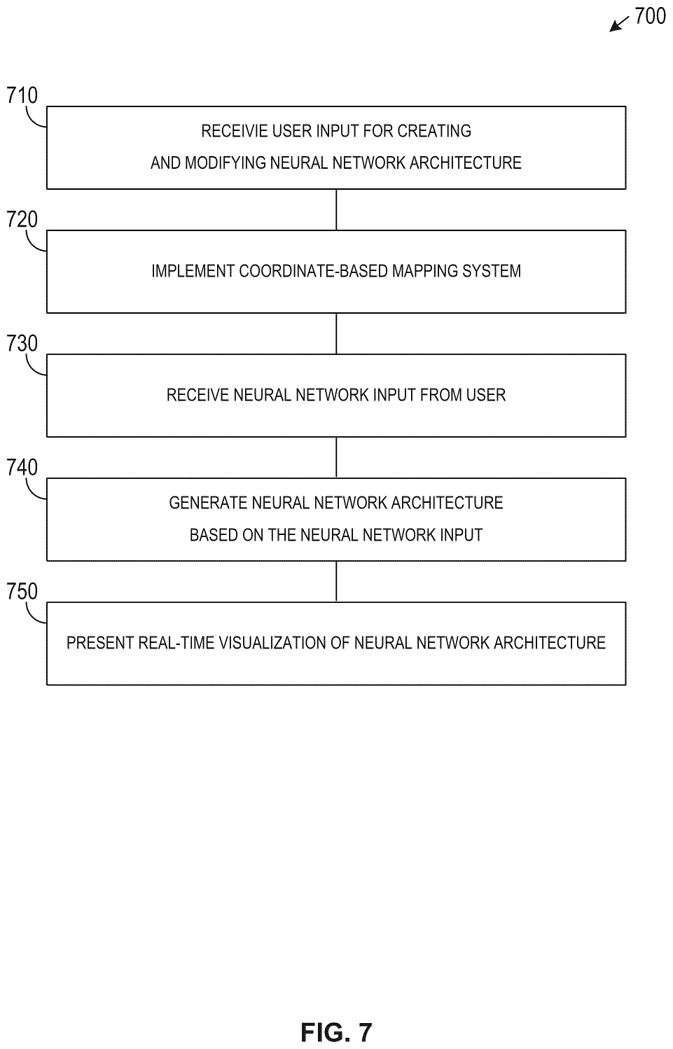

FIG. 7 is flowchart depicting a method 700 for improving neural network development efficiency, in accordance with at least one embodiment of the invention. Method 700 includes receiving 710, via a visual diagramming interface, user input for creating and modifying a neural network architecture. Method 700 includes implementing 720 a coordinate-based mapping system that reduces computational overhead by tracking neural network components through spatial identification based on layer position and placement order. The coordinate-based mapping system enables precise tracking and management of network components. Implementing the coordinate-based mapping system may further include assigning unique spatial coordinates based on layer position, tracking component relationships through coordinate references, and optimizing access to network components through spatial organization.

Method 700 includes receiving 730 a neural network input from a user that provides customization of individual neuron parameters through direct manipulation of a plurality of icons on the visual diagramming interface. This enables real-time modification of activation functions, weight initializations, and connectivity patterns. These modifications may include receiving user input modifying activation functions for individual neurons, dynamically updating weight initialization values, and reconfiguring neuron connectivity patterns in response to user modifications.

Method 700 includes automatically generating 740 a neural network architecture based on the neural network input. This may include generating the neural network logic and component details necessary for implementing the customized network configuration. Method 700 includes presenting 750, via the visual diagramming interface, a real-time visualization of the neural network architecture. This visualization provides both high-level architectural views and detailed component-level information to enable effective network development and refinement.

Method 700 may further include creating a heterogeneous neural network by at least one of implementing different activation functions across neurons within the heterogeneous neural network, applying varying weight initializations between neurons, or establishing non-uniform connectivity patterns. Method 700 may further include enabling simultaneous automated batch creation and manual customization by automatically generating multiple neurons based on user-specified parameters, allowing direct manipulation of individual neurons, and maintaining synchronized updates between batch and manual modifications.

Method 700 may further include providing a training interface that accepts training data through file upload or manual entry, processes training examples to optimize network performance, and enables real-time evaluation of network accuracy. Method 700 may further include implementing constant node networks by creating neurons with no inputs, integrating fixed-value nodes beyond input layers, and optimizing network performance through strategic constant node placement.

Method 700 may further include facilitating creation of amalgamated networks by combining different neural network configurations, enabling individual component training, and optimizing combined network performance. Method 700 may further include integrating gradient descent trained expert systems by establishing connections between neural network and expert system components, maintaining rule-fact relationships, and optimizing hybrid system performance. Method 700 may further include dynamically adjusting network visualization by providing multiple levels of architectural detail, enabling real-time component inspection, and optimizing display based on user interaction.

Method 700 may further include implementing a specialized network configuration, the specialized network configuration adapted to at least one of process hyperspectral image classification, detecting fraudulent transactions, or controlling autonomous vehicles. Method 700 may further include enabling iterative refinement through at least one of real-time performance monitoring, automated suggestion of optimizations, or immediate implementation of modifications. Method 700 may further include optimizing network performance through at least one of automated weight adjustment, dynamic bias modification, or adaptive connectivity pattern updates.

Method 700 may further include implementing backpropagation by calculating loss function gradients, adjusting weights and biases, and optimizing network accuracy. Method 700 may further include providing explainable AI capabilities through at least one of visualization of decision pathways, analysis of component relationships, or tracking of network operations. Method 700 may further include enabling experimental network development through at least one of template-based initialization, component-level modification, or performance-based optimization.

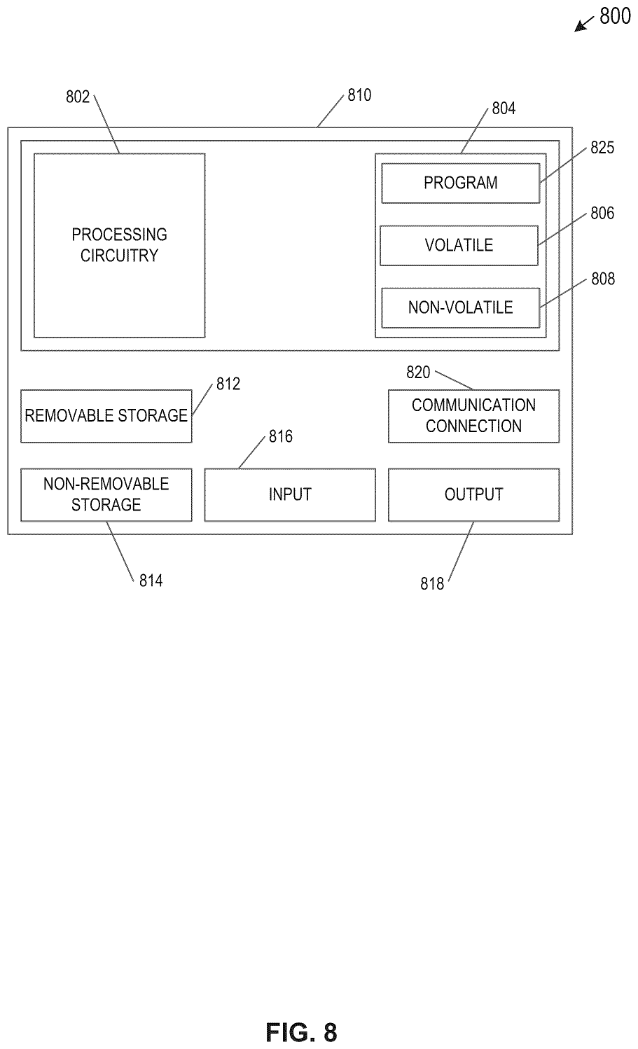

FIG. 8 is a block diagram of a computing device 800, according to an embodiment. The performance of computing device 800 may be improved by including one or more of the systems or methods for training artificial intelligence networks described herein. Computing device 800 may include processing circuitry 802 and memory 804 that include instructions, which when executed by the processing circuitry 802, configure the processing circuitry 802 to obtain a plurality of input facts from the memory device, generate a plurality of target network output results based on the input facts, and train an expert system rule network. The training of the expert system rule network may include iteratively performing the steps of generating a training rule network, generating a plurality of training output results based on the training rule network and the plurality of input facts, and generating a revised rule network based on a comparison between the plurality of training output results and the plurality of target network output results. The revised rule network may include a plurality of network rules, each of the plurality of network rules having an associated defensible rule weighting, each defensible rule weighting identifying a probabilistic mapping of the plurality of input facts to an output fact generated by the expert system rule network.

In one embodiment, multiple computing devices (e.g., such as computing device 800) are used in a distributed network to implement multiple components in a transaction-based environment. An object-oriented, service-oriented, or other architecture may be used to implement such functions and communicate between the multiple systems and components. In some embodiments, the computing device of FIG. 8 is an example of a client device that may invoke methods described herein over a network. In some embodiments, the computing device of FIG. 8 is an example of one or more of the personal computer, smartphone, tablet, or various servers.

One example computing device in the form of a computer 810, may include processing circuitry 802, memory 804, removable storage 812, and non-removable storage 814. Although the example computing device is illustrated and described as computer 810, the computing device may be in different forms in different embodiments. For example, the computing device may instead be a smartphone, a tablet, or other computing device including the same or similar elements as illustrated and described with regard to FIG. 8. Further, although the various data storage elements are illustrated as part of the computer 810, the storage may include cloud-based storage accessible via a network, such as the Internet.

Returning to the computer 810, memory 804 may include volatile memory 806 and non-volatile memory 808. Computer 810 may include or have access to a computing environment that includes a variety of computer-readable media, such as volatile memory 806 and non-volatile memory 808, removable storage 812 and non-removable storage 814. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 810 may include or have access to a computing environment that includes input 816, output 818, and a communication connection 820. The input 816 may include one or more of a touchscreen, touchpad, mouse, keyboard, camera, and other input devices. The input 816 may include a navigation sensor input, such as a GNSS receiver, a SOP receiver, an inertial sensor (e.g., accelerometers, gyroscopes), a local ranging sensor (e.g., LIDAR), an optical sensor (e.g., cameras), or other sensors. The computer may operate in a networked environment using a communication connection 820 to connect to one or more remote computers, such as database servers, web servers, and another computing device. An example remote computer may include a personal computer (PC), server, router, network PC, a peer device or other common network node, or the like. The communication connection 820 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing circuitry 802 of the computer 810. A hard drive (magnetic disk or solid state), CD-ROM, and RAM are some examples of articles including a non-transitory computer-readable medium. For example, various computer programs 825 or apps, such as one or more applications and modules implementing one or more of the methods illustrated and described herein or an app or application that executes on a mobile device or is accessible via a web browser, may be stored on a non-transitory computer-readable medium.

The apparatuses and methods described above may include or be included in high-speed computers, communication and signal processing circuitry, single-processor module or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, a list of items joined by the term “at least one of” may mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A may include a single element or multiple elements. Item B may include a single element or multiple elements. Item C may include a single element or multiple elements.

In the detailed description and the claims, a list of items joined by the term “one of” may mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A may include a single element or multiple elements. Item B may include a single element or multiple elements. Item C may include a single element or multiple elements.

Example 1 is a system for improving neural network development efficiency, the system comprising: processing circuitry coupled to a display device and configured to: present, on the display device, a visual diagramming interface that reduces neural network development complexity; implement a coordinate-based mapping system that optimizes component tracking through spatial organization; receive a neural network input from a user, the neural network input providing customization of individual neuron parameters through direct manipulation of a plurality of icons on the visual diagramming interface; generate a neural network architecture based on the neural network input, the neural network architecture including neural network logic and component details; and present, on the display device, a real-time visualization of the neural network architecture.

In Example 2, the subject matter of Example 1 includes wherein the processing circuitry is further configured to: enable modification of activation functions for individual neurons; update weight initialization values dynamically; and reconfigure neuron connectivity patterns in response to user input.

In Example 3, the subject matter of Examples 1-2 includes wherein the processing circuitry is further configured to create a heterogeneous neural network by implementing at least one of different activation functions across neurons, varying weight initializations, or non-uniform connectivity patterns.

In Example 4, the subject matter of Examples 1-3 includes wherein the processing circuitry is further configured to: enable simultaneous automated and manual neuron creation; maintain synchronized updates between batch and individual modifications; and optimize component organization through spatial tracking.

In Example 5, the subject matter of Examples 1-4 includes wherein the processing circuitry is further configured to: assign unique spatial coordinates based on layer position; track component relationships through coordinate references; and optimize access to network components.

In Example 6, the subject matter of Examples 1-5 includes wherein the processing circuitry is further configured to: provide a training interface that processes data inputs; enable real-time evaluation of network performance; and facilitate iterative refinement through immediate feedback.

In Example 7, the subject matter of Examples 1-6 includes wherein the processing circuitry is further configured to: implement constant node networks with fixed-value neurons; optimize network performance through strategic node placement; and enable integration beyond traditional input layers.

In Example 8, the subject matter of Examples 1-7 includes wherein the processing circuitry is further configured to: facilitate creation of amalgamated networks; enable individual and combined component training; and optimize overall network performance.

In Example 9, the subject matter of Examples 1-8 includes wherein the processing circuitry is further configured to: integrate gradient descent trained expert systems; maintain rule-fact relationships; and optimize hybrid system performance.

In Example 10, the subject matter of Examples 1-9 includes wherein the processing circuitry is further configured to: provide multiple levels of architectural visualization; enable real-time component inspection; and optimize display based on user interaction.

In Example 11, the subject matter of Examples 1-10 includes wherein the processing circuitry is further configured to implement a specialized network configuration, the specialized network configuration adapted to at least one of process hyperspectral image classification, detect fraudulent transactions, or control autonomous vehicles.

In Example 12, the subject matter of Examples 1-11 includes wherein the processing circuitry is further configured to enable iterative refinement through at least one of real-time performance monitoring, automated suggestion of optimizations, or immediate implementation of modifications.

In Example 13, the subject matter of Examples 1-12 includes wherein the processing circuitry is further configured to optimize network performance through at least one of automated weight adjustment, dynamic bias modification, or adaptive connectivity pattern updates.

In Example 14, the subject matter of Examples 1-13 includes wherein the processing circuitry is further configured to implement backpropagation by: calculating gradients; adjusting network parameters; and optimizing accuracy.

In Example 15, the subject matter of Examples 1-14 includes wherein the processing circuitry is further configured to provide explainable AI capabilities through at least one of visualization of decision pathways, analysis of component relationships, or tracking of network operations.

In Example 16, the subject matter of Examples 1-15 includes wherein the processing circuitry is further configured to enable experimental development through at least one of template-based initialization, component-level modification, or performance-based optimization.

Example 17 is a method for improving neural network development efficiency, the method comprising: receiving, via a visual diagramming interface, user input for creating and modifying a neural network architecture; implementing a coordinate-based mapping system that reduces computational overhead by tracking neural network components through spatial identification based on layer position and placement order; receiving a neural network input from a user, the neural network input providing customization of individual neuron parameters through direct manipulation of a plurality of icons on the visual diagramming interface; automatically generating a neural network architecture based on the neural network input, the neural network architecture including neural network logic and component details; and presenting, via the visual diagramming interface, a real-time visualization of the neural network architecture.

In Example 18, the subject matter of Example 17 includes wherein enabling real-time customization includes: receiving user input modifying activation functions for individual neurons; dynamically updating weight initialization values; and reconfiguring neuron connectivity patterns in response to user modifications.

In Example 19, the subject matter of Examples 17-18 includes creating a heterogeneous neural network by at least one of implementing different activation functions across neurons within the heterogeneous neural network, applying varying weight initializations between neurons, or establishing non-uniform connectivity patterns.

In Example 20, the subject matter of Examples 17-19 includes enabling simultaneous automated batch creation and manual customization by: automatically generating multiple neurons based on user-specified parameters; allowing direct manipulation of individual neurons; and maintaining synchronized updates between batch and manual modifications.

In Example 21, the subject matter of Examples 17-20 includes wherein implementing the coordinate-based mapping system includes: assigning unique spatial coordinates based on layer position; tracking component relationships through coordinate references; and optimizing access to network components through spatial organization.

In Example 22, the subject matter of Examples 17-21 includes providing a training interface that: accepts training data through file upload or manual entry; processes training examples to optimize network performance; and enables real-time evaluation of network accuracy.

In Example 23, the subject matter of Examples 17-22 includes implementing constant node networks by: creating neurons with no inputs; integrating fixed-value nodes beyond input layers; and optimizing network performance through strategic constant node placement.

In Example 24, the subject matter of Examples 17-23 includes facilitating creation of amalgamated networks by: combining different neural network configurations; enabling individual component training; and optimizing combined network performance.

In Example 25, the subject matter of Examples 17-24 includes integrating gradient descent trained expert systems by: establishing connections between neural network and expert system components; maintaining rule-fact relationships; and optimizing hybrid system performance.

In Example 26, the subject matter of Examples 17-25 includes dynamically adjusting network visualization by: providing multiple levels of architectural detail; enabling real-time component inspection; and optimizing display based on user interaction.

In Example 27, the subject matter of Examples 17-26 includes implementing a specialized network configuration, the specialized network configuration adapted to at least one of process hyperspectral image classification, detect fraudulent transactions, or control autonomous vehicles.

In Example 28, the subject matter of Examples 17-27 includes enabling iterative refinement through at least one of real-time performance monitoring, automated suggestion of optimizations, or immediate implementation of modifications.

In Example 29, the subject matter of Examples 17-28 includes optimizing network performance through at least one of automated weight adjustment, dynamic bias modification, or adaptive connectivity pattern updates.

In Example 30, the subject matter of Examples 17-29 includes implementing backpropagation by: calculating loss function gradients; adjusting weights and biases; and optimizing network accuracy.

In Example 31, the subject matter of Examples 17-30 includes providing explainable AI capabilities through at least one of visualization of decision pathways, analysis of component relationships, or tracking of network operations.

In Example 32, the subject matter of Examples 17-31 includes enabling experimental network development through at least one of template-based initialization, component-level modification, or performance-based optimization.

Example 33 is a non-transitory computer-readable media storing instructions that, when executed by one or more processors, cause the one or more processors to perform operations for improving neural network development efficiency, the operations comprising: receiving, via a visual diagramming interface, user input for creating and modifying a neural network architecture; implementing a coordinate-based mapping system that reduces computational overhead by tracking neural network components through spatial identification based on layer position and placement order; receiving a neural network input from a user, the neural network input providing customization of individual neuron parameters through direct manipulation of a plurality of icons on the visual diagramming interface; automatically generating a neural network architecture based on the neural network input, the neural network architecture including neural network logic and component details; and presenting, via the visual diagramming interface, a real-time visualization of the neural network architecture.

In Example 34, the subject matter of Example 33 includes wherein enabling real-time customization includes: receiving user input modifying activation functions for individual neurons; dynamically updating weight initialization values; and reconfiguring neuron connectivity patterns in response to user modifications.

In Example 35, the subject matter of Examples 33-34 includes wherein the operations further include creating a heterogeneous neural network by at least one of implementing different activation functions across neurons within the heterogeneous neural network, applying varying weight initializations between neurons, or establishing non-uniform connectivity patterns.

In Example 36, the subject matter of Examples 33-35 includes wherein the operations further include enabling simultaneous automated batch creation and manual customization by: automatically generating multiple neurons based on user-specified parameters; allowing direct manipulation of individual neurons; and maintaining synchronized updates between batch and manual modifications.

In Example 37, the subject matter of Examples 33-36 includes wherein implementing the coordinate-based mapping system includes: assigning unique spatial coordinates based on layer position; tracking component relationships through coordinate references; and optimizing access to network components through spatial organization.

In Example 38, the subject matter of Examples 33-37 includes wherein the operations further include providing a training interface, wherein: the training interface accepts training data through file upload or manual entry; the training interface processes training examples to optimize network performance; and the training interface enables real-time evaluation of network accuracy.

In Example 39, the subject matter of Examples 33-38 includes wherein the operations further include implementing constant node networks by: creating neurons with no inputs; integrating fixed-value nodes beyond input layers; and optimizing network performance through strategic constant node placement.

In Example 40, the subject matter of Examples 33-39 includes wherein the operations further include facilitating creation of amalgamated networks by: combining different neural network configurations; enabling individual component training; and optimizing combined network performance.

In Example 41, the subject matter of Examples 33-40 includes wherein the operations further include integrating gradient descent trained expert systems by: establishing connections between neural network and expert system components; maintaining rule-fact relationships; and optimizing hybrid system performance.

In Example 42, the subject matter of Examples 33-41 includes wherein the operations further include dynamically adjusting network visualization by: providing multiple levels of architectural detail; enabling real-time component inspection; and optimizing display based on user interaction.

In Example 43, the subject matter of Examples 33-42 includes wherein the operations further include implementing a specialized network configuration, the specialized network configuration adapted to at least one of process hyperspectral image classification, detect fraudulent transactions, or control autonomous vehicles.

In Example 44, the subject matter of Examples 33-43 includes wherein the operations further include enabling iterative refinement through at least one of real-time performance monitoring, automated suggestion of optimizations, or immediate implementation of modifications.

In Example 45, the subject matter of Examples 33-44 includes wherein the operations further include optimizing network performance through at least one of automated weight adjustment, dynamic bias modification, or adaptive connectivity pattern updates.

In Example 46, the subject matter of Examples 33-45 includes wherein the operations further include implementing backpropagation by: calculating loss function gradients; adjusting weights and biases; and optimizing network accuracy.

In Example 47, the subject matter of Examples 33-46 includes wherein the operations further include providing explainable AI capabilities through at least one of visualization of decision pathways, analysis of component relationships, or tracking of network operations.

In Example 48, the subject matter of Examples 33-47 includes wherein the operations further include enabling experimental network development through at least one of template-based initialization, component-level modification, or performance-based optimization.

Example 49 is at least one machine-readable medium including instructions that, when executed by processing circuitry, cause the processing circuitry to perform operations to implement of any of Examples 1-48.

Example 50 is an apparatus comprising means to implement of any of Examples 1-48.

Example 51 is a system to implement of any of Examples 1-48.

Example 52 is a method to implement of any of Examples 1-48.

The apparatuses and methods described above may include or be included in high-

speed computers, communication and signal processing circuitry, single-processor module or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, a list of items joined by the term “at least one of” may mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A may include a single element or multiple elements. Item B may include a single element or multiple elements. Item C may include a single element or multiple elements.

In the detailed description and the claims, a list of items joined by the term “one of” may mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A may include a single element or multiple elements. Item B may include a single element or multiple elements. Item C may include a single element or multiple elements.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system for improving neural network development efficiency, the system comprising:
processing circuitry coupled to a display device and configured to:
present, on the display device, a visual diagramming interface that reduces neural network development complexity;
implement a coordinate-based mapping system that optimizes component tracking through spatial organization;
receive a neural network input from a user, the neural network input providing customization of individual neuron parameters through direct manipulation of a plurality of icons on the visual diagramming interface;
generate a neural network architecture based on the neural network input, the neural network architecture including neural network logic and component details; and
present, on the display device, a real-time visualization of the neural network architecture.

2. The system of claim 1, wherein the processing circuitry is further configured to:
enable modification of activation functions for individual neurons;
update weight initialization values dynamically; and
reconfigure neuron connectivity patterns in response to user input.

3. The system of claim 1, wherein the processing circuitry is further configured to create a heterogeneous neural network by implementing at least one of different activation functions across neurons, varying weight initializations, or non-uniform connectivity patterns.

4. The system of claim 1, wherein the processing circuitry is further configured to:
enable simultaneous automated and manual neuron creation;
maintain synchronized updates between batch and individual modifications; and
optimize component organization through spatial tracking.

5. The system of claim 1, wherein the processing circuitry is further configured to:
assign unique spatial coordinates based on layer position;
track component relationships through coordinate references; and
optimize access to network components.

6. The system of claim 1, wherein the processing circuitry is further configured to:
provide a training interface that processes data inputs;
enable real-time evaluation of network performance; and
facilitate iterative refinement through immediate feedback.

7. The system of claim 1, wherein the processing circuitry is further configured to:
implement constant node networks with fixed-value neurons;
optimize network performance through strategic node placement; and
enable integration beyond traditional input layers.

8. The system of claim 1, wherein the processing circuitry is further configured to:
facilitate creation of amalgamated networks;
enable individual and combined component training; and
optimize overall network performance.

9. The system of claim 1, wherein the processing circuitry is further configured to:
integrate gradient descent trained expert systems;
maintain rule-fact relationships; and
optimize hybrid system performance.

10. A method for improving neural network development efficiency, the method comprising:
receiving, via a visual diagramming interface, user input for creating and modifying a neural network architecture;
implementing a coordinate-based mapping system that reduces computational overhead by tracking neural network components through spatial identification based on layer position and placement order;
receiving a neural network input from a user, the neural network input providing customization of individual neuron parameters through direct manipulation of a plurality of icons on the visual diagramming interface;
automatically generating a neural network architecture based on the neural network input, the neural network architecture including neural network logic and component details; and
presenting, via the visual diagramming interface, a real-time visualization of the neural network architecture.

11. The method of claim 10, wherein enabling real-time customization includes:
receiving user input modifying activation functions for individual neurons;
dynamically updating weight initialization values; and
reconfiguring neuron connectivity patterns in response to user modifications.

12. The method of claim 10, further including creating a heterogeneous neural network by at least one of implementing different activation functions across neurons within the heterogeneous neural network, applying varying weight initializations between neurons, or establishing non-uniform connectivity patterns.

13. The method of claim 10, further including enabling simultaneous automated batch creation and manual customization by:
automatically generating multiple neurons based on user-specified parameters;
allowing direct manipulation of individual neurons; and
maintaining synchronized updates between batch and manual modifications.

14. The method of claim 10, wherein implementing the coordinate-based mapping system includes:
assigning unique spatial coordinates based on layer position;
tracking component relationships through coordinate references; and
optimizing access to network components through spatial organization.

15. The method of claim 10, further including implementing constant node networks by:
creating neurons with no inputs;
integrating fixed-value nodes beyond input layers; and
optimizing network performance through strategic constant node placement.

16. The method of claim 10, further including facilitating creation of amalgamated networks by:
combining different neural network configurations;
enabling individual component training; and
optimizing combined network performance.

17. The method of claim 10, further including integrating gradient descent trained expert systems by:
establishing connections between neural network and expert system components;
maintaining rule-fact relationships; and
optimizing hybrid system performance.

18. A non-transitory computer-readable media storing instructions that, when executed by one or more processors, cause the one or more processors to perform operations for improving neural network development efficiency, the operations comprising:
receiving, via a visual diagramming interface, user input for creating and modifying a neural network architecture;
implementing a coordinate-based mapping system that reduces computational overhead by tracking neural network components through spatial identification based on layer position and placement order;
receiving a neural network input from a user, the neural network input providing customization of individual neuron parameters through direct manipulation of a plurality of icons on the visual diagramming interface;
automatically generating a neural network architecture based on the neural network input, the neural network architecture including neural network logic and component details; and
presenting, via the visual diagramming interface, a real-time visualization of the neural network architecture.

19. The non-transitory computer-readable media of claim 18, wherein the operations further include enabling simultaneous automated batch creation and manual customization by:
automatically generating multiple neurons based on user-specified parameters;
allowing direct manipulation of individual neurons; and
maintaining synchronized updates between batch and manual modifications.

20. The non-transitory computer-readable media of claim 18, wherein implementing the coordinate-based mapping system includes:
assigning unique spatial coordinates based on layer position;
tracking component relationships through coordinate references; and
optimizing access to network components through spatial organization.
